(19) United States
(12) Patent Application Publication
(10) Pub. No.: US 2010/0312589 A1
(43) Pub. Date: Dec. 9, 2010

(54) METHOD AND SYSTEM FOR IDENTIFYING AND EVALUATING THE RISK OF FAILURE OF A GEOLOGICAL CONFINEMENT SYSTEM

(75) Inventors: Bruno Gerald, Montigny Sur Loing (FR); Laurent Auge, Fontainebleau (FR); Richard Frenette, Avon (FR); Emmanuel Houdu, Fontainebleau (FR); Olivier Bernard, Lausanne (CH); Jérôme Le Gouevec, Paris (FR)

Correspondence Address: YOUNG & THOMPSON, 209 Madison Street, Suite 500, Alexandria, VA, 22314, US

(73) Assignee: OXAND, Avon (FR)

(21) Appl. No.: 12/279,184

(22) PCT Filed: Feb. 22, 2007
(86) PCT No.: PCT/FR2007/000317

§ 371 Date: Dec. 12, 2008

(30) Foreign Application Priority Data
Feb. 22, 2006 (FR) 0601539

(51) Int. Cl. G06Q 10/00

(52) U.S. Cl. 705/7

(57) ABSTRACT

A method for identifying the risk of failure of a geological confinement system (10), includes the following steps: acquiring data concerning the system; based on said data concerning the system, breaking down the system into a plurality of components (11-17); modelling at least one component by at least one volume (131-134), the modelling being performed by discretizing in volume the component; generating at least one failure scenario of the system, the generation including at least one iteration of the following steps: analyzing a state of at least one volume modelling at least one component of the system; detecting, based on the state of the volume, at least one potential failure mode of the volume. The inventive method and system enable the risks of failure of any system of geological confinement, natural and/or artificial, in particular oil tanks used for storing CO₂, to be identified.

This invention relates to a method and system for the identification and evaluation of the risk of failure of a geological confinement system.

This method aims in particular to secure, by a risk identification and assessment, all types of geological confinement systems whether they are natural or artificial.

The field of the invention is that of geological confinement systems. The geological confinement systems can be for example geological confinement systems such as oil reservoirs, potable or salt water aquifers, etc.

The invention relates to the identification of the risks associated with a confinement system created by man, for example a system for storing CO₂ in an oil reservoir: in this case the invention aims to determine the risks of failure of the storage system and to propose the securing of this system making it possible, for example, to prevent a failure which would result in leakage of the stored CO₂. The invention also relates to the evaluation of the risks of failure of a natural confinement system, such as a potable aquifer: in this case it makes it possible to determine the risks of contamination of the aquifer from whatever origin.

Currently, securing means exist for certain types of geological confinement systems such as underground formations serving as storage cavities. The latter are, in general, secured using isolation devices comprising, for example, at least one plug, very often as a cement slurry of whatever composition or also based on clay with bentonite. These securing means are based on feedback from experience of durability over several decades and involve no long-term problems, nor environmental impact. In addition, these securing means are very often incomplete as they do not take enough parameters into account.

Moreover, the securing means currently used relate to securing elements which are taken in isolation and do not take account of either interactions between these securing elements, or the behaviour of these elements on the ground.

Currently, no reliable and exhaustive means exist which make it possible to know the risks represented by geological confinement systems used to store a substance of whatever nature. Moreover, it is no longer possible, with the means used currently, to know the dangers represented by these geological confinement systems used as storage sites in case of failure. Finally, the current securing methods are of a standard and general nature, and do not allow the treatment of geological confinement systems case by case. This constitutes a major drawback given the diversity of geological confinement systems.

In the remainder of this patent application, by “biosphere” is meant all the components comprised between the atmosphere and an underground depth of approximately 300 m. Therefore it comprises in particular the atmosphere, the hydrosphere, the soil, formations at a shallow depth and the fauna and flora present in these zones. By “geosphere” is meant all components situated at a depth greater than approximately 300 m: it encompasses geological data, hydrological data, data relating to reservoirs, as well as the elements introduced by man: exploitation wells, trial wells, keywells etc.

An objective of this invention is to resolve the above-mentioned drawbacks.

This invention aims to propose a method and a system making it possible to obtain the identification and an evaluation of the risk of failure of a geological confinement system, which is quicker and more certain at less cost than existing identification methods and systems.

Another objective of the invention is to propose a method for the identification and evaluation of the risk of failure of a geological confinement system, which is more complete than current methods, by combining theoretical studies carried out in this field with the reality of the terrain.

An objective of this invention is also to propose a method for the identification and evaluation of the risk of failure of a geological confinement system which makes it possible to treat each geological confinement system specifically, so as to propose securing means suited to each geological confinement system.

Finally an objective of this invention is to take into account a multitude of parameters allowing a geological confinement system to be secured in a more exhaustive manner than current methods.

The invention proposes to remedy the abovementioned drawbacks with a method for the identification of the risk of failure of a geological confinement system, said method comprising the following stages:
acquisition of data relating to said system;
as a function of said data relating to said system, breakdown of said system into a plurality of components;
modelling of at least one component by at least one volume, said modelling being carried out by a discretization into volumes of said component;
generation of at least one failure scenario of said system, said generation comprising at least one iteration of the following stages:
   analysis of a state of at least one volume modelling at least one component of said system;
   detection, as a function of the state of the volume, of at least one potential failure mode of said volume;

By the acquisition of data relating to the geological confinement system, the method according to the invention makes it possible to take into account the reality of the terrain. Moreover, by carrying out a breakdown of the confinement system into components, by modelling these components by volumes, and by analyzing these volumes one by one, the method according to the invention advantageously makes it possible to propose an exhaustive identification of the risks of failure of the system with at least one scenario associated with each risk. Knowing the failure scenario associated with a risk, the operator has the possibility of acting so as to prevent this failure scenario and therefore minimizing this risk of failure by suitable securing.

By carrying out a modelling of the confinement system in the form of volume, the method according to the invention makes it possible to produce an identification of the risk of failure in a more certain fashion, which is quicker and less expensive. Moreover, this breakdown makes it possible to carry out a theoretical and empirical study of the underground confinement system taking into account the reality of the terrain.

The breakdown, by the method according to the invention, of the geological confinement system into a plurality of components which are themselves modelled by volumes makes it possible to treat each confinement system in a specific manner. In fact, by breaking down a confinement system into a plurality of components, then modelling these components by volumes a more elementary level of study is reached.

By working not only on an overall view but on a broken-down view of the confinement system studied, it is possible to carry out studies which are on the one hand specific to each system because a specific composition is studied, and on the other hand universal because this study method is suitable for all confinement systems. Moreover, the study carried out is then quite exhaustive as this study method makes it possible to treat each volume representing a component of the system taken in isolation or in combination with at least one other volume so as to take into account the interactions between several volumes and several components modelled by these volumes.

Advantageously, the method according to the invention makes it possible to treat all confinement systems whether or not equipped with a technical installation comprising elements such as “casings” made up of a plurality of telescopic tubes. For example, it makes it possible to carry out identification of the risk of failure of an underground formation used to carry out storage of a fluid, a gas or any other substance.

A particular example of use of the method according to the invention is the identification of the risk of failure of an underground formation used to store CO₂. Such a formation can be an oil reservoir. In fact, the storage of CO₂ in oil reservoirs requires a technical installation making it possible to ensure the imperviousness of the formation or the reservoir, so as to prevent CO₂ leakage over a significant period of time.

It is then essential to know the risks of failure of the reservoir. The method according to the invention advantageously makes it possible to identify the risks of failure of an oil reservoir used to store CO₂ over a predetermined period of time. Moreover, it makes it possible to identify the scenarios associated with a risk of failure, and makes it possible to identify technical solutions allowing these scenarios to be prevented.

“Discretization in volumes” of a component means a modelling of this component by discrete volumes. This discretization takes into account the component itself and the material surrounding this component, and in particular all the layers of the biosphere and the geosphere. This discretization makes it possible to model the overall volume formed by at least one component and its environment by at least one discrete entity, called volume. In this modelling by discretization in volumes, the characteristics of the volumes represent the characteristics of the overall volume modelled. The fineness of the discretization ensures the preservation of the continuity of the whole of the overall volume modelled,

In fact, the discretization of the system to be adopted must make it possible to analyze, in a precise and relevant manner, the interactions between the components, and the interactions of a component with its environment, then, failure modes of the latter.

For example, the architecture of a drilled well is often very dependent on the geology encountered: the change in the well column most often coincides with a significant change in the properties of the geological stratum passed through, and the presence of cemented sleeves is most often dictated by the sensitive or even incompatible character of the formation.

Moreover, an “overburden”, defined as being all of the formations situated between a reservoir and the surface, is usually divided into geological strata which can possess very different properties: permeability, water content, etc.

Also, for example, it can be chosen to model an overall geological volume composed of a set of faults by one or more discrete volumes, each characterized in particular by an equivalent vertical permeability.

The method according to the invention makes it possible to carry out identification of the risks of failure of a geological confinement system. Such a system is very complex and identification of the risks of failure of such a system involves a multitude of parameters.

Moreover, the method according to the invention makes it possible to carry out an identification of the risk of failure of a confinement system in the long term and makes it possible to evaluate the environmental impact of a failure of such a system.

The method according to the invention advantageously comprises a stage of proposing at least one solution for ensuring security making it possible to prevent a failure scenario. In fact, the method according to the invention makes it possible to propose to a user the appropriate actions available to him to prevent a scenario of the failure of a geological confinement system and ensure its reliability. The actions which can be proposed may comprise:
implementation of targeted technological solutions in order to increase the isolation of one or other component and/or geological volume;
implementation of monitoring means in order to check the absence of significant leaks at critical points of a confinement system; and
carrying out additional soundings/measurements in order to reduce uncertainties regarding the most critical properties of the components and/or volumes.

A solution for ensuring security can require updating of the identification of the risks of failure of the geological confinement system. For example, implementation of a solution for maintaining the operational integrity of the system can require a new discretization into volumes of the system and of all the following stages in the identification and evaluation of the risks of failure of the system. Similarly, implementation of monitoring solutions on at least one critical volume of the system can require a new generation of failure scenarios and a quantification of these failure scenarios.

Moreover, before the stage of proposal of at least one solution for ensuring security, the method according to the invention can comprise a stage of identification of at least one source of the risk of failure. As a preliminary to definition of the solution for treating the most critical scenarios, it is necessary to identify the macro-risk(s) at the origin of these scenarios: is it uncertainty regarding degradation kinetics? uncertainty regarding the initial state of the system? the geometry? is it a particular component of the system? a particular process linked, for example, to the confinement strategy? a weakness in the design of the confinement system? Accelerated ageing tests in the laboratory or complementary studies can be carried out in order to answer these questions. In the particular case of an oil reservoir used for the confinement of CO₂, a campaign for more precise characterization of the oil field or a reengineering of the reservoir, for example a modification or a technical improvement in the design of the reservoir, can be envisaged.

Advantageously, the data relating to the confinement system, acquired for the implementation of the method according to the invention, comprise data relating to a technical installation equipping the confinement system. This technical installation can be an installation making it possible to ensure the confinement function in order to prevent a leakage from a storage structure on the one hand, and intrusion into the system of an undesirable element from outside on the other hand. This installation can for example be made up of at least one plug constructed of material of any kind and in particular of cement, at least one cemented sleeve, at least one fluid, at least one “casing” and components made from steel of any kind, etc.

The data relating to the technical installation can comprise at least one characteristic of at least one component of this installation. These characteristics can comprise the composition of the component, a state of the component, a position of the component, a dimension of the component, a behaviour of the component, etc.

According to an advantageous version of the method according to the invention, the data relating to the confinement system comprise data relating to the biosphere and/or to the geosphere in and/or around said system. In fact, for a confinement system which can comprise a plurality of geological formations, risks of failures exist which are linked to the biosphere and the geosphere surrounding and in proximity to the system. This is the reason why it is necessary to take the geosphere and the biosphere into account. By way of example, for an oil reservoir used to store CO₂, it is important to consider the geosphere and biosphere layers surrounding the reservoir in order to detect a risk of CO₂ leakage through these layers.

According to an advantageous feature of the invention, the data relating to the confinement system comprise data relating to the content of said system. In this way, it is possible to carry out identification of the risks of possible failures as well as identification of the dangers linked to the content of the confinement. In fact, the nature and characteristics of the content of the confinement system can give rise to risk situations under certain conditions: explosion under high pressure, corrosion of a technical installation, incompatibility between a technical installation and the content of the confinement system, etc. It is important to be able to take into account the nature and characteristics of the content in the identification of the risk of failure of the confinement system.

Advantageously, the data relating to the confinement system comprise a two-dimensional or three-dimensional representation of said system in its environment. This makes it possible to take into account the components of the geological confinement system and to construct a modelling into volumes having functionalities and interactions with each other, so as to achieve an exhaustive and more representative modelling of the geological confinement system. The two-dimensional or three-dimensional representation can be a symmetrical section of at least one component and/or volume of the geological confinement system according to a functional angle.

According to an advantageous feature of the invention, the data relating to the confinement system comprise monitoring data of said system. These monitoring data can be real-time data, acquired by sensors placed in proximity to or within the geological confinement system.

Advantageously, the identification of a failure scenario takes into account the data relating to at least one environmental condition. These environmental conditions can be taken into account by an acquisition of data relating to these conditions. The environmental conditions can comprise seismographic, atmospheric, climatic conditions, human activities, use of the surrounding zones, etc.

According to an advantageous version of the invention, at least one volume models at least one component of the confinement system. For example, a storage system in an oil reservoir can be represented by volumes modelling, as appropriate, a casing, a plug, annular cement, a reservoir, a fluid, etc.

Similarly, at least one volume models at least one component forming part of the geosphere and/or biosphere situated within or in proximity to the confinement system. For example, a component of the geosphere or biosphere, such as a geological or biological formation, a lake, a cavity, etc., can be represented by a volume.

Each volume representing a component belonging to the geological confinement system or to a technical installation equipping the system or to the geosphere and/or biosphere, can comprise at least one characteristic relating to the component that it models. These characteristics can comprise data relating to a state, behaviour, development, nature, etc. of the component modelled. Thus, a volume can in reality become a macro-entity comprising a plurality of data representing a plurality of characteristics of a component. These characteristics can be expressed by functions or equations.

Advantageously, the method according to the invention can also comprise a selection from a base of at least one predefined volume making it possible to model at least one component of the confinement system. In fact, the invention can comprise a predefined “volumes” data base making it possible to represent a component of the geological confinement system, a component of a technical installation equipping this system, or a component of the biosphere and/or geosphere in or around the system. Thus, the modelling of the confinement system can be carried out very quickly. Moreover, the predefined volumes can be completed or modified to take into account a feature of one or more components.

In an advantageous version of the method according to the invention, the analysis of the state of a volume comprises an evaluation of at least one physico-chemical characteristic of the volume under predetermined conditions. The analysis of a component, carried out by means of at least one volume representing this component, can comprise theoretical calculations relating to behaviour of the component over time, taken in isolation, or in combination with other elements. These calculations can be carried out for a particular situation of use of the component with a plurality of scenarios of development over time. The purpose of this analysis is to identify at least one failure mode of the component over time, in situations of particular use, following a plurality of development scenarios.

Such an analysis of the state of a volume by determination of at least one physico-chemical characteristic of this volume at time t can be called a static analysis of the state of the volume. Moreover, the modelling of at least one volume as a function of its state determined by static analysis can be called a static modelling of this volume. Thus, if all the elements of the confinement system are modelled in a static manner then the confinement system is modelled in a static manner.

The analysis of the state of a volume can comprise taking into account a development kinetics of this volume over time, optionally starting with the state of the volume at an earlier time t. In certain cases, it is not possible to define an a priori state for a volume; it is easier to define degradation kinetics, comprising for example a degradation “rule” as a function of the environment and the flow of CO2. Moreover, the degradation kinetics parameters can thus also be at the origin of the definition of scenarios: the scenario s is defined by the volume v being in a state x at such a date and evolving according to the kinetics c starting from this date. Thus, the method according to the invention can comprise determination of a failure mode of a volume as a function of development kinetics relating to this volume and at least one failure scenario can be determined as a function of this failure mode.

Such an analysis of a state of the volume as a function of the development kinetics of this volume can be called a dynamic analysis of the volume. A modelling of at least one volume using a dynamic analysis of the state of the volume can be called a dynamic modelling of this volume. Similarly, if all the elements of the confinement system are modelled in a dynamic manner then the confinement system is modelled in a dynamic manner.

Of course, a confinement system can be modelled using either dynamic modelling or static modelling, or a combination of the two. For example, one volume of the confinement system can be modelled in a dynamic manner and another in a static manner.

According to an advantageous version of the method according to the invention, a failure scenario comprises a combination of a plurality of failure modes of a plurality of volumes. In fact, in the example of an oil reservoir used to store CO₂, CO₂ leakage can be caused by failure of a plurality of components of the reservoir, of the technical installation intended to ensure the imperviousness of the reservoir, and of the surrounding formations.

For example, for a scenario of leakage of a content from a cavity, the method according to the invention makes it possible to define at least one leakage route, corresponding to the path of the leakage of content to the surface.

Advantageously, the analysis of the state of a volume comprises taking into account a state of at least one other volume among a plurality of volumes. In fact, the behaviour of a component modelled by at least one volume can be calculated under predefined conditions. If these conditions are changed, these changes must be taken into account in order to most precisely define the behaviour of a component. For example, in the case of storage of CO₂ in an oil reservoir equipped with a well provided with of two abandonment plugs the role of which have is to ensure the imperviousness of the reservoir, the pressure to which the abandonment plug 2 is subjected is not the same if the abandonment plug 1 is faulty. Its behaviour over time will be changed and this must be taken into account. Account must therefore be taken of the state of the plug 1 in order to model the plug 2.

The method according to the invention, taking into account the interaction between the components of a geological confinement system, makes it possible to carry out the most precise and complete identification of the risk of failure of the system.

The method according to the invention can also comprise a stage of choosing at least one failure scenario from a plurality of failure scenarios. In fact, analysis of the state of a component of a geological confinement system can lead to a plurality of failure modes of this component, which will lead to a plurality of failure scenarios of the system. In this case, the method according to the invention can comprise a choice of one failure scenario from a plurality of failure scenarios according to predefined criteria.

According to an advantageous feature of the invention, at least one volume is associated with a so-called frequency factor, said frequency factor being evaluated at least as a function of a probability of failure of said volume.

For each failure mode and optionally for each cause of failure of each of the volumes, these occurrence frequencies can be obtained in several ways:
expert opinions;
quantitative simulations;
statistical data and feedback from experience

According to an advantageous feature of the invention, at least one failure scenario is associated with a so-called frequency factor, said frequency factor being evaluated as a function of a probability of occurrence of said scenario.

These occurrence frequencies can be evaluated as a function of the data relating to the volumes to which this scenario relates. They can be obtained in several ways:
expert opinions;
quantitative simulations;
statistical data and feedback from experience;
calculation by combination of the frequency factors of the volumes involved

Advantageously, a so-called gravity factor is associated with at least one failure scenario, said gravity factor being evaluated as a function of the consequences of said scenario. In fact, for each failure scenario, the method according to the invention can comprise an estimation of the damage caused by a failure which can be calculated.

The consequences of a failure of the confinement system can be of two orders:
loss of expected performance of the confinement function, such as for example a loss of a stored substance by excessive leakage or contamination by intrusion of elements from outside, reducing or even eliminating the benefit of the storage;
damage linked to the harmful effect or dangerousness of the stored substance.

The damage taken into account can be damage relating to the geological confinement system and a technical installation equipping this system, and damage caused to the environment by such a failure. Among these kinds of damage, there can for example be mentioned those caused by leakage of contents from a cavity.

The evaluation of the gravity factor can comprise taking into account a flow rate of the leakage of contents from said confinement system and/or the level of intrusion into said confinement system. For example, in the case of an oil reservoir containing CO₂, it is possible to estimate the damage caused by a failure scenario which involves CO₂ leakage. The estimation of the gravity of CO₂ leakage can in particular comprise the damage caused to the environment and to the operator.

Advantageously, at least one gravity factor can be associated with at least one predetermined issue. In fact, the method according to the invention can comprise determination of the consequences of a failure scenario by evaluation of the impact of the different issues defined on the scale of a geological confinement project in case of failure: issues for the operator and for the environment. It makes it possible to relate the performance of the confinement system and the level of impact of the different issues using performance indicators, for example leakage flow rates or an intrusion level. A CO₂ leakage flow rate x causes exploitation losses of x days for the operator and can put the lives of others at risk within a certain surface perimeter. The method is applied when:
the consequences are quantified: a cost, and
the consequences are not quantified: a decision to exclude this type of confinement from an industrial policy if more than x % of stored gas is lost over a given period.

The method according to the invention can also comprise a simulation making it possible to quantitatively estimate a failure scenario, for example a leakage flow rate.

The method according to the invention can also comprise a simulation making it possible to quantitatively estimate the evolution of the state of a volume over time as a function of evolution kinetics and of a state of this volume at a time t. For example, in the case of a plug of a well used for the storage of CO₂, the method according to the invention can comprise an evaluation, by the use of the law of leaching for example, of the development of the permeability of the plug starting with a state at time t, for example a cracked plug, and given development kinetics.

The method according to the invention can moreover comprise criticality evaluation of a failure scenario as a function of a frequency factor and/or a gravity factor. The criticality can be estimated as a function of the damage and frequency of occurrence of the failures. Thus, it is possible to envisage several levels of criticality. This makes it possible to distinguish failure scenarios which are more critical than others and thus to treat these scenarios as a priority.

Advantageously, the method according to the invention can comprise identification and/or prioritization of at least one failure scenario as a function of the criticality of at least one failure scenario. This can make it possible, in the particular example of CO₂ storage in an oil reservoir, to identify a critical CO₂ route for example, and therefore to advise CO₂ monitoring at a particular location, or to recommend placing a new isolation plug at such a level.

The method according to the invention can also comprise criticality evaluation of a failure mode of a volume, as a function of a frequency factor and of a contribution of said volume to at least one most critical scenario. This criticality can be determined by redistributing the criticality of a scenario among the volumes involved in this scenario and of the corresponding failures.

Advantageously, the method according to the invention can comprise identification and/or prioritization of at least one failure mode of at least one volume as a function of a criticality of at least one failure mode of at least one other volume. It is thus possible to map the risks at the level of at least one volume of the geological confinement system, thus highlighting the sensitive character of the volume at the level of the overall system. This can make it possible, in the particular example of CO₂ storage in an oil reservoir, to reveal the critical volumes and therefore, for example, to demonstrate the need for more specific degradation studies of this volume under its direct environmental conditions.

Advantageously, once the failure scenarios have been identified and quantified according to a criticality index, the method according to the invention can comprise a robustness test allowing validation of the exhaustiveness of the significant criticality scenarios, i.e. mapping covering the risks of the scenarios. This stage makes it possible to ensure that no possible source of risk is forgotten. It involves gauging the influence of a certain number of uncertainties taken into account by the definition of the working hypotheses. This stage precedes the stage of identification of the source of risk. In the case of a CO₂ confinement system, this test is carried out as follows:
variation of at least one modelling parameter which was not the basis of the definition of at least one failure scenario, the working hypotheses comprising conditions relating to gas pressure limits and physical properties;
verification leakage obtained: if leakage varies little with these parameters, or at least remains below an acceptable upper value, then the robustness test is satisfactory, if not an additional failure scenario is added.

Moreover, the method according to the invention can also comprise, for at least one scenario, evaluation of uncertainty regarding this scenario. In fact, as a function of the precision of the information, its importance, quantity and quality, the invention makes it possible to define the uncertainty relating to the failure scenarios identified as well as the risks associated with these scenarios.

Several solutions are possible for evaluating the uncertainty of a scenario:
in the case where the failure phenomena or modes can be parameterized or modelled, a quantitative calculation can be carried out. This calculation can be carried out in two different ways:
   determining the probabilities of exceeding criteria (for example limit flow rate) over time, starting with distributions regarding the input parameters (considered as random variables) of the different components and/or volumes;
   or determining the uncertainty interval on the indicator (flow rate for example) of the scenario starting with the uncertainty intervals of the different failure modes (processing the imperfect knowledge of the system data);
in the contrary case, evaluation of the uncertainty is carried out by qualitative-type reasoning.

The method according to the invention can advantageously comprise identification and/or prioritization of at least one failure scenario of the geological confinement system projected to a predetermined future date and more particularly to different short, medium and long-term deadlines. In particular it makes it possible to highlight the developments in the risks resulting from the geological confinement system since its establishment and in the long term. In the example of CO₂ storage in oil reservoirs, evaluation of the risks can thus focus on the phases of injection (short term), rebalancing of pressures (short-medium term), and actual storage (medium and long term).

Advantageously the method according to the invention can be implemented for the identification of the risk of failure of an oil reservoir used to store CO₂.

The method according to the invention can advantageously be implemented in all the phases of a confinement project. Such a confinement project can comprise preliminary study of the confinement system, long term monitoring, passing through the injection phase and the abandonment phase. In the particular case of drilled wells, the preliminary study of the confinement system for example can comprise design of the technical installations of drilled wells and the geological configuration.

The method according to the invention can be implemented for the analysis of the risks of failure of a confinement system intended to be abandoned or already abandoned. In a particular application example, the method according to the invention can be implemented for the analysis of the abandoning of an oil field.

The method according to the invention can also be implemented for the analysis of the risks of failure and of the evaluation of the performances of a confinement system provided for seasonal storage, for example of natural gas.

According to another aspect of the invention, a system of identification of the risk of failure of a geological confinement system is proposed, said system comprising:
means for the acquisition of data relating to said system;
means for breaking down said system into a plurality of components as a function of said data relating to said system;
means for modelling at least one component by at least one volume, said modelling being carried out by a discretization into volumes of said component;
means for generating at least one failure scenario of said system, said generation comprising at least one iteration of the following stages:
   analysis of a state of at least one volume modelling at least one component of said system;
   detection, as a function of the state of the volume, of at least one potential failure mode of said volume;

Other advantages and characteristics will become apparent on examination of the detailed description of an embodiment which is in no way limitative, and the attached drawings in which

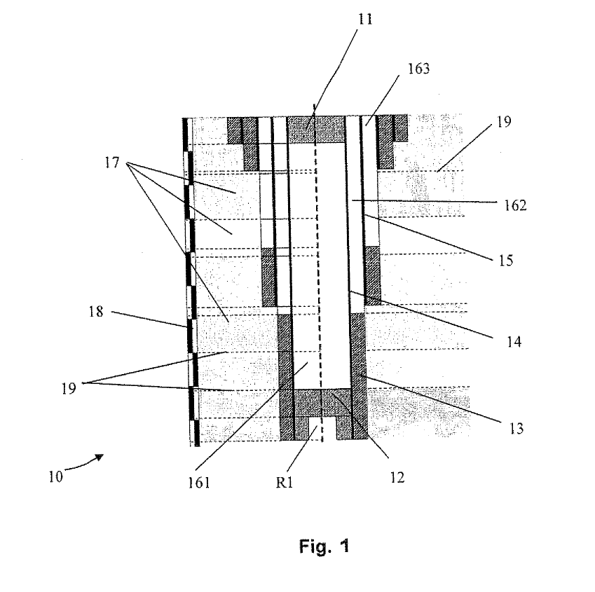

FIG. 1 is a diagrammatic representation of a drilled well and the surrounding material;

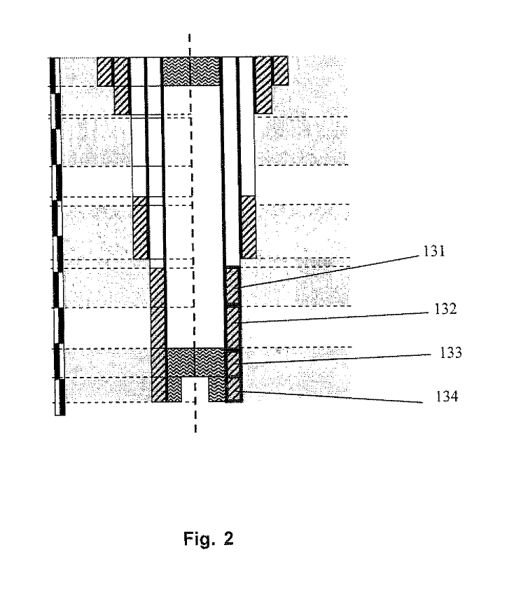

FIG. 2 is a diagrammatic representation of an example of modelling according to the invention of a component of a drilled well by volumes;

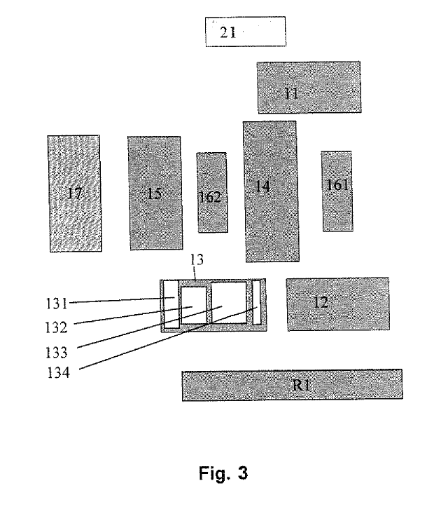

FIG. 3 is a representation of a breakdown of a well into components and a modelling of a component by volumes, in accordance with the method according to the invention;

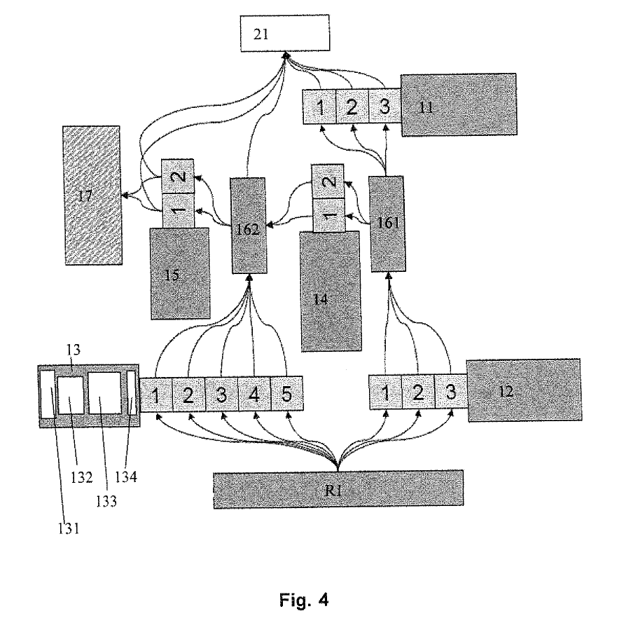

FIG. 4 is a representation of a network of leakage by a well of the contents of an oil reservoir;

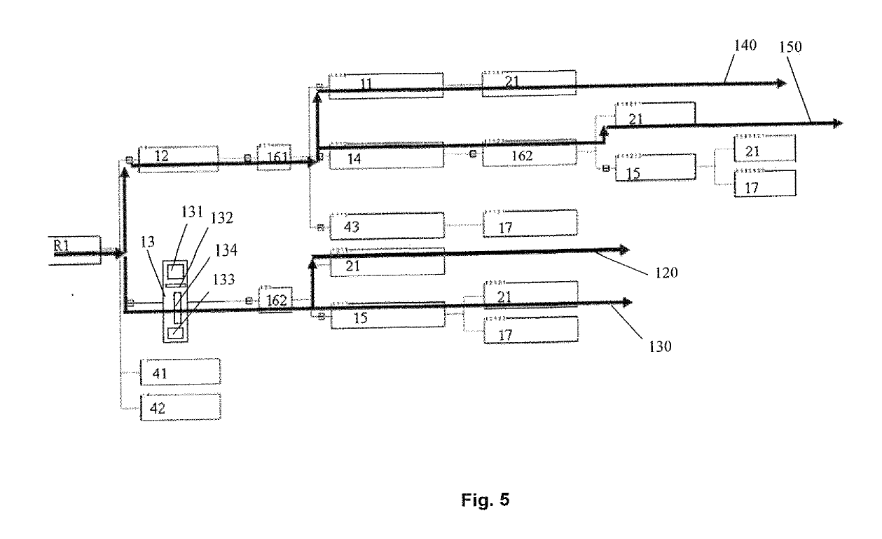

FIG. 5 is a diagrammatic representation of several leakage routes constituting a possible failure of a well studied according to the method according to the invention;

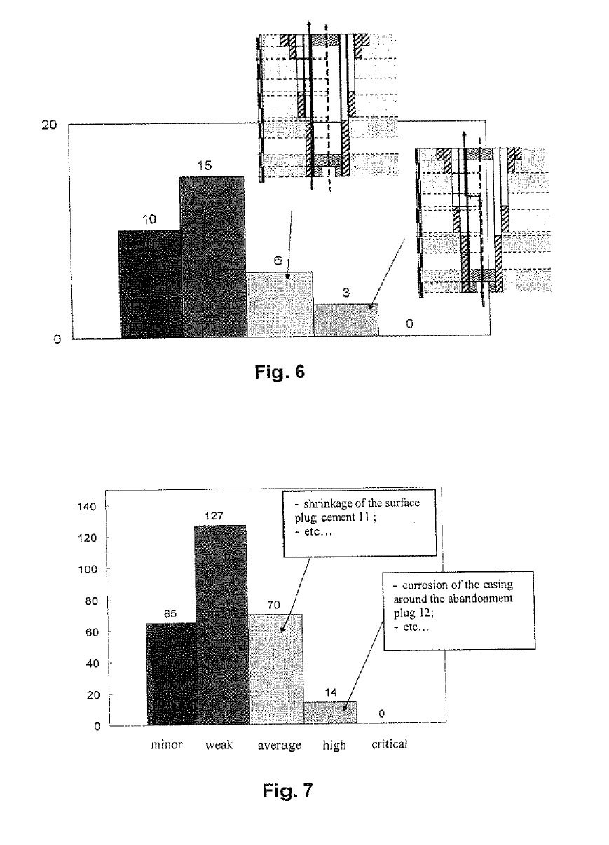

FIG. 6 is an example of the classification of the failure scenarios of a well by the method according to the invention;

FIG. 7 is an example of the classification of the failures of the different components of a geological confinement system in accordance with the method according to the invention;

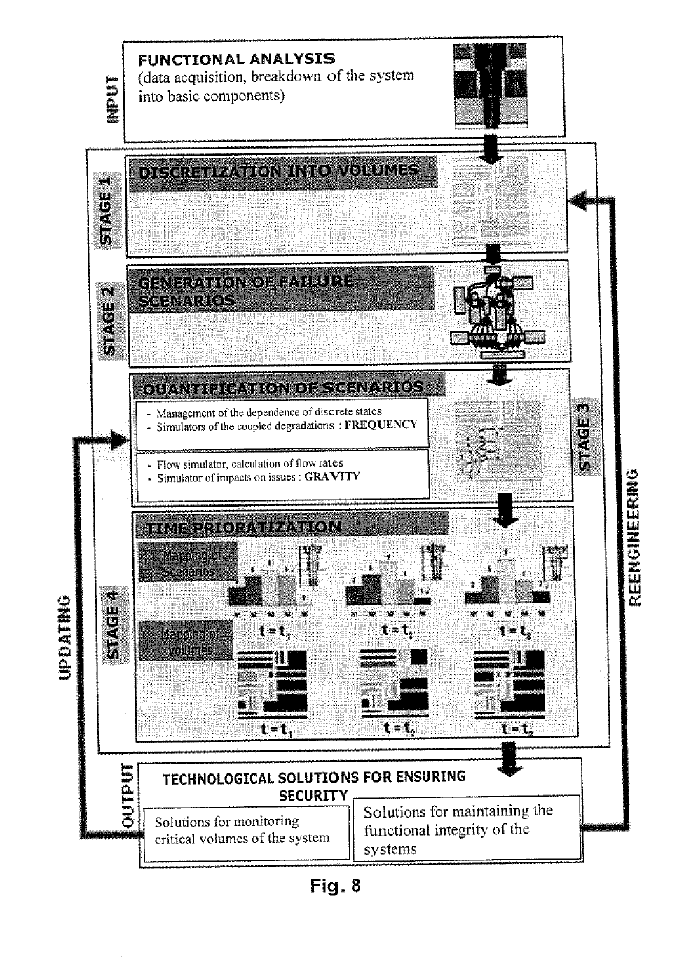

FIG. 8 is an example of a procedure for the identification and evaluation of the risk of failure according to the invention.

The particular and in no way limitative example described in detail below relates to the evaluation of the risks of failure of a plugged well (10), in a CO₂ storage environment, constituting a technical installation aimed at guaranteeing the imperviousness of storage. The risk evaluation will take into account a biosphere-geosphere system, over a certain reference period T. The description of this example can be given in the form of a plurality of stages.

### Preliminary Stage: Functional Analysis

After acquisition of the data relating to the well (10) and its environment, the method according to the invention also comprises a preliminary stage of identification and analysis of the different components of the well. The well is then seen as a “well” system, comprising basic components which interact with each other and with the outside: earthquakes, external pressures, etc. This stage makes it possible, in a first phase, to highlight the functions which must be performed by each of the components within the “well” system. Diagram 1 below makes it possible to illustrate the elements inside or outside the system which can be taken into account in the risk analysis and storage well securing process:

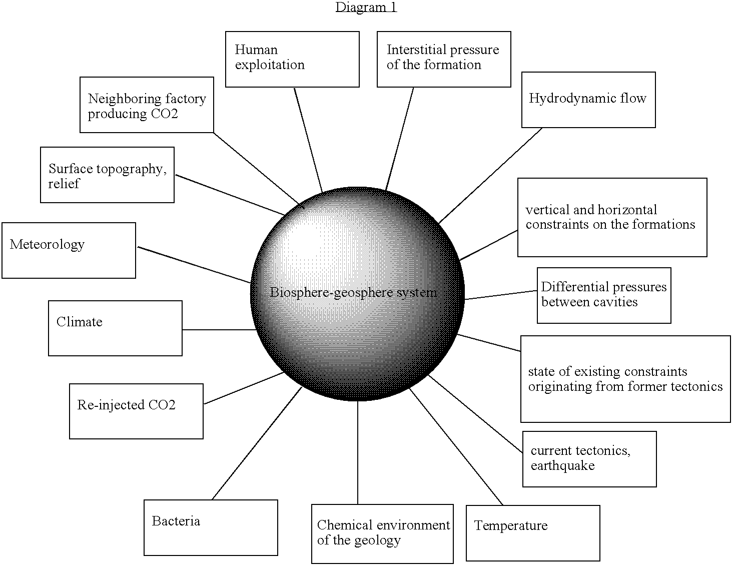

Each of the elements is then scanned one by one and for each of them the constraints likely to be imposed on the components of the system are taken into account.

Analysis of these elements makes it possible to show the data listed in a table. Table 1 is an illustration of this.

TABLE 1

| | Affected | Functions of constraints on the affected |
|---|---|---|
| Element | component | component |
| reinjected | well cemented | To resist permeation into the cemented elements (under |
| CO2 | elements | the effect of a pressure gradient) |
| | | To resist diffusion into the cemented elements (under the |
| | | effect of a concentration gradient) |
| | | To resist progression of CO₂ gas bubbles into the cemented |
| | | elements |
| | casings | To resist displacement of the filling fluids through the |
| | | pierced casings |
| | | To resist corrosion of the casings under the effect of water |
| | | loaded with CO₂ |
| | | etc. |
| | reservoir | |
| | reservoir cover | To resist permeation into the reservoir cover etc. |
| | faults | To resist the flow of fluids loaded with CO₂ |
| | | etc. along the faults |
| Chemical | well | . . . |
| environment | | |
| of the geology | | |
| Earthquake | well | . . . |
| | overburden | . . . |
| | reservoir cover | . . . |
| Temperature | Well | . . . |
| | Reservoir cover | . . . |
| State of | . . . | . . . |
| existing | | |
| constraints on | | |
| the formations | | |
| Overpressure | . . . | . . . |
| in the | | |
| formations | | |
| Human | reservoir cover | . . . |
| exploitation | faults | . . . |

Stage 1: Discretization into Volumes

FIG. 1 diagrammatically represents the storage well studied. The latter comprises a reservoir R1, cement plugs 11 and 12, cement sleeves 13, “casings” 14 and 15, at least one fluid 161, 162, 163 and formations 17 forming part of the geosphere and surrounding biosphere. The depth relative to the surface of the location of all these components is given by a vertical axis 18.

The well in FIG. 1 was then discretized into volumes making it possible to model the components of the well. The discretization was carried out taking into account the limits 19 between the different formations. FIG. 3 shows the discretization obtained. The discretization was carried out, in a first phase, following the basic components encountered, then the latter were divided into as many volumes as geological horizontal strata passed through, as represented in FIG. 2 for the cement sleeve component 13. Thus the cement sleeve component 13 was discretized in four volumes, namely volumes 131, 132, 133, and 134 as a function of the formations 17 forming part of the surrounding geosphere.

FIG. 3 shows volumes which model a reservoir R1, the abandonment plug 12, the cemented sleeve 13, production casings 14 and 15, fluids 161 and 162, neighbouring formations 17, the abandonment plug 11 and the surface 21.

Stage 2: Generation of Failure Scenarios

2.1: Construction of the Event Tree

As a function of the results of Stage 1, a CO₂ leakage network (or event tree) is established, in FIG. 4. The network is made up of a plurality of leakage routes. These leakage routes are established as a function of the failure modes of the well volumes. In fact, as can be observed in FIG. 4, for each well volume at least one discrete state exists, listed from 1 to 5. For example, for the cemented sleeve 13, and each of the volumes 134, 133, 132, 131, five degradation states are listed.

2.2: Analysis by Volumes

For each of the discretized volumes, analysis is carried out by producing an inventory of the failure modes which can affect the component modelled by the volume. The failures can be seen as degradations over time of the properties of the volume or sudden damage to the volume following discrete events, according to the case.

The failures are exhaustively inventoried by studying:
the impact of outside aggressions;
the interactions of at least one other volume with the volume studied;
development kinetics of the volume or of an adjacent volume.

The failures of the volumes are listed then classified as a function of a frequency factor. In this example, illustrated by Table 2 and the case of the cement sleeve 13 and volume 134, the failure modes (lines in the table) are characterized by assigning a frequency index to each possible degree of magnitude of the failure (columns in the table). The frequency index is defined in Table 3, as a function of a qualitative or quantitative probability of occurrence. This approach makes it possible to integrate uncertainties about the data relating to the system or the models used, which are inescapable when the future of a component in the long term (100 to 10,000 years) is evaluated.

TABLE 2

| Volume (for | | | | | | | | |
|---|---|---|---|---|---|---|---|---|
| example, 131 | | | Degree of | | | | | |
| or 132 or | Failure mode | | magnitude of the failure | | | | | |
| 133 or 134) | (FM) | Causes | K0* | α K0 | etc . . . | | | |
| Volume 134 | Leaching | by water in the | | 2 | 1 | 1 | 1 | 1 |
| | | formations | | | | | | |
| | | decalcification | | 1 | 1 | 1 | 1 | 1 |
| | | by H2S | | | | | | |
| | Carbonation | By CO2 | | 1 | 1 | 1 | 1 | 1 |
| | Fissuring | stresses on the | | 1 | 1 | 1 | 1 | 1 |
| | | formations | | | | | | |
| | etc . . . | | | 1 | 1 | 1 | 1 | 1 |
| | | | | 1 | 1 | 1 | 1 | 1 |
| | | | | 5 | 2 | 1 | 1 | 1 |

| | | | | | | |
|---|---|---|---|---|---|---|
| Overall state including | U % | V % | W % | X % | Y % | Z % |
| all of the FMs | | | | | | |
| Overall frequency index | 3 | 5 | 2 | 1 | 1 | 1 |
| for the volume | | | | | | |

*K0 represents the parameter of permeability of the component in its safe reference state

Table 2 shows all of the failure modes and their rating on the basis of a frequency index, for the volume 134.

The possible degrees of magnitude of the failures (columns in the table) are classified here on the basis of the resulting permeability of the volume.

Each failure mode is rated according to the structure of the table as a function of the data relating to the volumes concerned and under predetermined conditions.

TABLE 3

| Description | Class, level | Associated probability |
|---|---|---|
| Impossible or admitted as such | 1 | P1 |
| Very improbable | 2 | P2 |
| Improbable | 3 | P3 |
| Probable | 4 | P4 |
| Very probable | 5 | P5 |
| Certain | 6 | P6 |

Finally, all of the modes and causes of failure of the volume, and their different frequency indices are integrated, so as to establish the probability distribution of possible states for the volume. The results are illustrated for the case of the cemented sleeve 13 and volume 134, by the last two lines in Table 2. The standard rules for calculating probabilities are used. Once the probability has been calculated (penultimate line of Table 2), the frequency is rated with reference to the grid given in Table 3 (last line of Table 2).

This is an example of qualitative reasoning associated with determination of the probabilities of the possible different states of the volume (last two lines of Table 2):
starting with the right-hand column (the most harmful state) the probability of the volume being in this state is written as being equal to the sum of the probabilities of being in this state according to each of the causes (causes admitted as being independent of each other). If there is only a single cause, the corresponding probability is reported directly,
this reasoning is continued for the other states of the volume in order of decreasing harmful character (columns from right to left), bearing in mind that the sum of the probabilities of the different possible states of the volume is of course equal to one (the possible different states are disjointed: if one state is probable, the others are necessarily improbable overall).

2.3: Generation of the Failure Scenarios

The failure scenarios, defined here as a combination of states of the volumes encountered on a given leakage route, are constructed by analysis of the interactions of flows between volumes and coupled degradations.

In our example of the storage well, several leakage routes and several leakage scenarios can be identified. Still considering a failure of the cemented sleeve 13 and more precisely of volume 134, two leakage routes 120 and 130 are identified and represented in FIG. 5.

FIG. 5 shows a different presentation of the leakage routes. This representation shows the different well volumes and a plurality of possible CO₂ leakage routes. For example, there is a broken well column 43, a reservoir cover 41, faults 42, a pierced internal column casing 15. There are also the elements of the well listed above.

For the leakage route 120, CO₂ leakage occurs as follows: from the CO₂ reservoir R1, the CO₂ passes through the cemented sleeve 13 and the different volumes 134, 133, 132 and 131, then through the fluid 162, in order to arrive at the surface 21.

Let us now consider the route 130 shown in FIG. 5. The CO₂ leakage occurs from the reservoir towards the surface through, firstly, the cemented sleeve 13 and different volumes 134, 133, 132 and 131, then the fluid 161, then the casing 15, then the fluid 163, in order to arrive at the surface 21.

Stage 3: Quantification of the Scenarios

Analysis of the failure scenarios in terms of risk is carried out by consideration of a frequency factor and a gravity factor of the scenario.

The frequency factor is quantified by the calculation of a frequency for the scenario considered, carried out starting with the frequencies of the different states of the volumes involved, established in Stage 2. This frequency or probability is then represented qualitatively by a frequency index, already defined previously (see Table 3).

The gravity factor is here based on the value of the surface flow rates of CO₂ leakage originating from the well. The associated gravity index is shown in Table 4.

TABLE 4
Gravity grid adopted

| | Surface flow rate originating |
|---|---|
| Level | from the well |
| 1: Minor | Less than a [t/year] |
| 2: Weak | a to b [t/year] |
| 3: Serious | b to c [t/year] |
| 4: Major | c to d [t/year] |
| 5: Critical | d to e [t/year] |
| 6: Catastrophic | More than e [t/year] |

The scenario's gravity rating is assigned after calculation of the flow rate of CO₂ leakage through the well, according to the scenario considered, i.e. according to the failures of the volumes involved in this scenario.

Returning to the leakage route 120 generated in Stage 2. A study of the components involved in the route 120, their considered states, failure scenarios and their ratings are given. This study is illustrated by Table 5.

TABLE 5

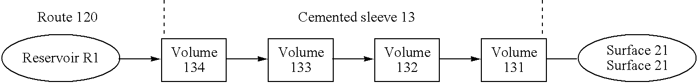

| | | | | | Frequency of the | | | |
|---|---|---|---|---|---|---|---|---|
| | | | | | leakage route | | | |
| | | | | | according to the | Flow | | |
| Combination of states | Volumes encountered | | | | combination of states | rate | G | C |
| Most probable Combination | State 2 | State 2 | State 2 | State 2 | F = 4 | <at/year | 1 | 5 |
| of states (i = 1) | (F = 5) | (F = 4) | (F = 4) | (F = 4) | | | | |
| Combination of states 2 | State 1 | State 1 | State 1 | State 1 | F = 3 | <at/year | 1 | 4 |
| | (F = 3) | (F = 4) | (F = 4) | (F = 4) | | | | |
| etc. . . | | | | | | | | |

In this example, the most probable scenario (line 1) is indicated first, i.e. the scenario involving the most probable states of the volumes encountered, followed by the less probable states. The frequencies of the leakage route according to each of the combinations of states considered are calculated starting with the frequencies assigned to the volumes involved, optionally by introducing conditional probabilities. The associated flow rates are calculated.

In this example, the criticality of the scenario is obtained by finding the sum of the frequency rating and the gravity rating. In our example, it is noted that the most critical scenario is identified with the most probable scenario.

In the same way as for the route 120, a study of the volumes involved in the route 130, their considered states, failure scenarios and their ratings are given. This study is illustrated by Table 6.

TABLE 6

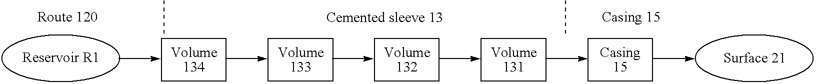

| | | | | | | Frequency of the | | | |
|---|---|---|---|---|---|---|---|---|---|
| | | | | | | leakage route | | | |
| | | | | | | according to the | Flow | | |
| Combination of states | Volumes encountered | | | | | combination of states | rate | G | C |
| Most probable Combination | State 2 | State 2 | State 2 | State 2 | bored | F = 4 | C [b; c] | 3 | 7 |
| of states (i = 1) | (F = 5) | (F = 4) | (F = 4) | (F = 4) | (F = 5) | | t/year | | |
| Combination of states 2 | State 1 | State 1 | State 1 | State 1 | bored | F = 3 | C [d; e] | 5 | 8 |
| | (F = 3) | (F = 4) | (F = 4) | (F = 4) | (F = 5) | | t/year | | |
| etc. . . | | | | | | | | | |

For this leakage route, it is noted that the most critical scenario is not identified with the most probable scenario.

The rating of the leakage scenarios is carried out for the other leakage routes identified for the volume 134, then for the other volumes.

Stage 4: Time Prioritization

4.1: Mapping of the Failure Scenarios

Stage 3 has made it possible to identify the scenarios and assign a criticality rating to them, representing their risk index. These scenarios can therefore from now be prioritized on the basis of their criticality, in order to obtain an overall mapping of the failure scenarios of the storage function. FIG. 6 illustrates the mapping obtained in this example at a given date. It is shown here that one of the most critical scenarios, i.e. producing the highest leakage flow rate risk, is the scenario involving CO₂ rising to the surface through the first plug 12 then the pierced casing 14 (leakage route 150, FIG. 5).

4.2: Mapping of the Volumes

Here it is sought to demonstrate the volumes at risk in the storage system. The invention makes it possible to carry out this demonstration retrospectively, once the overall failure scenarios have been identified and prioritized. Qualitatively, it appears clear that the most critical volume of the system is the most determining volume of the volumes involved in the most critical scenario.

In this study, the results can be presented as in FIG. 7. FIG. 7 shows a prioritization at a given date of the different failure modes of the various volumes as a function of their criticality: minor, weak, average, high, critical.

Final Stage: Technological Solutions for Ensuring Security (Risk Reduction)

In this example, the results of identification of the risk of failure of the CO₂ storage function in a reservoir equipped with a plugged well, established by the method according to the invention, highlight the following most critical risks:
the risk associated with the corrosion of the casings around the abandonment plug 12 and with the possible subsequent creation of a micro-annular interstice (plug/casing interface);
the risk linked to the piercing by corrosion of the casings of the different columns and to inadequate abandonment arrangements (inadequate number of plugs).

These results can for example justify the following security recommendations:
Re-engineering of the well for repair and utilization of additional cement plugs covering all of the well columns;
Deepening by specific studies and laboratory tests of knowledge about the phenomenon of corrosion level with the deep plug 12 (degradation kinetics, production of oxides, impact on resulting permeability at the cement/casing interface etc.).

FIG. 8 provides a summary of the different operations carried out and their sequences during an example of evaluation of the risks of failure of a plugged well, in a CO₂ storage environment, constituting a technical installation intended to guarantee the imperviousness of the storage.

The invention is not limited to the example which has just been described and can be applied to any geological confinement system.

1. Method for the identification of the risk of failure of a geological confinement system (10), said method comprising the following stages:
acquisition of data relating to said system (10);
as a function of said data relating to said system (10), breakdown of said system into a plurality of components (11-17);
modelling of at least one component (11-17) by at least one volume (131-134), said modelling being carried out by a discretization into volumes of said component (11-17);
generation of at least one failure scenario of said system, said generation comprising at least one iteration of the following stages:
analysis of a state of at least one volume (131-134) modelling at least one component (11-17) of said system;
detection, as a function of the state of the volume (11-17), of at least one potential failure mode of said volume (11-17);

2. Method according to claim 1, characterized in that it also comprises a stage of proposing at least one solution for ensuring security making it possible to prevent a failure scenario.

3. Method according to claim 1, characterized in that it also comprises a stage of choosing at least one failure scenario from a plurality of failure scenarios.

4. Method according to claim 1, characterized in that it also comprises a stage of identification of at least one source of risk of failure for at least one failure scenario.

5. Method according to claim 1, characterized in that it also comprises a selection from a base of at least one predefined volume (131-134) making it possible to model at least one component (11-17) of the confinement system (10).

6. Method according to claim 1, characterized in that a so-called frequency factor is associated with at least one volume (131-134), said frequency factor being evaluated at least as a function of a probability of failure of said volume (131-134).

7. Method according to claim 1, characterized in that a so-called frequency factor is associated with at least one failure scenario, said frequency factor being evaluated as a function of a probability of the occurrence of said scenario.

8. Method according to claim 1, characterized in that a so-called gravity factor is associated with at least one failure scenario, said gravity factor being evaluated as a function of the consequences of said scenario.

9. Method according to claim 8, characterized in that the evaluation of the gravity factor comprises taking into account a flow rate of leakage of contents from said confinement system (10) and/or the level of intrusion into said confinement system (10).

10. Method according to claim 8, characterized in that at least one gravity factor is associated with at least one predetermined issue.

11. Method according to claim 1, characterized in that it also comprises criticality evaluation of a failure scenario as a function of a frequency factor and/or a gravity factor.

12. Method according to claim 11, characterized in that it also comprises identification and/or prioritization of at least one failure scenario as a function of criticality of at least one other scenario failure.

13. Method according to claim 1, characterized in that it also comprises criticality evaluation of a failure mode of a volume, as a function of a frequency factor and a contribution of said volume to at least one most critical scenario.

14. Method according to claim 13, characterized in that it also comprises identification and/or prioritization of at least one failure mode of at least one volume (131-134) as a function of a criticality of at least one failure mode of at least one other volume (131-134).

15. Method according to claim 1 characterized in that the analysis of the state of a volume (131-134) comprises evaluation of at least one physico-chemical characteristic of the volume (131-134) under predetermined conditions.

16. Method according to claim 1, characterized in that the analysis of the state of a volume (131-134) comprises taking into account a state of at least one other volume (131-134) among a plurality of volumes (131-134).

17. Method according to claim 1, characterized in that it also comprises a simulation making it possible to quantitatively estimate a failure scenario.

18. Method according to claim 1, characterized in that it also comprises a simulation making it possible to quantitatively estimate the development of a state of a volume over time.

19. Method according to claim 1, characterized in that the analysis of the state of a volume (131-134) comprises taking into account the development kinetics of said volume (131-134).

20. Method according to claim 1, characterized in that the data relating to the confinement system (10) comprise data relating to a technical installation equipping the confinement system (10).

21. Method according to claim 1, characterized in that the data relating to the confinement system (10) comprise data relating to the biosphere and/or geosphere in and/or around said system (10).

22. Method according to claim 1, characterized in that the data relating to the confinement system (10) comprise data relating to the contents of said system (10).

23. Method according to claim 1, characterized in that the data relating to the confinement system (10) comprise a two-dimensional or three-dimensional representation of said system (10) in its environment.

24. Method according to claim 1, characterized in that the data relating to the confinement system (10) comprise data of the monitoring of said system (10).

25. Method according to claim 1, characterized in that at least one volume (131-134) models at least one component (11-17) of the confinement system.

26. Method according to claim 1, characterized in that a volume (131-134) models at least one component (11-17) forming part of the geosphere and/or biosphere located within or in proximity to the confinement system (10).

27. Method according to claim 1 characterized in that a failure scenario comprises a combination of a plurality of failure modes of a plurality of volumes (131-134).

28. Method according to claim 1, characterized in that it also comprises, for at least one scenario, evaluation of an uncertainty for said scenario.

29. Method according to claim 1, characterized in that the identification of a failure scenario takes into account the data relating to at least one environmental condition.

30. Method according to claim 1, characterized in that it comprises identification and/or prioritization of at least one failure scenario of the geological confinement system projected to a predetermined future date.

31. Method according to claim 1, characterized in that it is implemented for the evaluation of the risk of failure of a confinement system used to store CO₂.

32. Method according to claim 1, characterized in that it is implemented for the analysis of the abandonment of an oil field.

33. System of identification of the risk of failure of a geological confinement system (10), said system comprising:
means for the acquisition of data relating to said system (10);
means for the breakdown of said system into a plurality of components (11-17) as a function of said data relating to said system (10);
means for modelling at least one component (11-17) by at least one volume (131-134), said modelling being carried out by a discretization into volumes of said component (11-17);
means for the generation of at least one failure scenario of said system (10), said generation comprising at least one iteration of the following stages:
analysis of a state of at least one volume (131-134) modelling at least one component (11-17) of said system (10);
detection, as a function of the state of the volume, of at least one potential failure mode of said volume (131-134).
